(19) United States
(12) Patent Application Publication
(10) Pub. No.: US 2020/0082346 A1
(43) Pub. Date: Mar. 12, 2020

(54) COMPUTER-IMPLEMENTED METHOD AND SYSTEM FOR VERIFYING CREDENTIALING INFORMATION

(71) Applicant: Ravi Tandra, Quantico, VA (US)

(72) Inventor: Ravi Tandra, Quantico, VA (US)

(21) Appl. No.: 16/125,661

(22) Filed: Sep. 8, 2018

(51) Int. Cl. G06Q 10/10

(52) U.S. Cl. CPC G06Q 10/1053

(57) ABSTRACT

A system and computer-implemented method for facilitating verification of employment and/or education credentials provided to an online information service, as well as other user-provided credentialing information. The method includes means of verifying third-party employment, date ranges, titles, coworkers and employers, through input of third-party data, URL cross-referencing and correspondence credentialing data exchanged with the third-party data.

### BACKGROUND OF THE INVENTION

### Field of the Invention

This invention relates generally to online information processing and provision, and more specifically relates to verification of employment credentials.

### Description of the Related Art

Online information services providing prospective employers with credentialing information about prospective employees are known in the art. Typically, these systems connect employers and employees by allowing both to register with, and displaying and allowing search of, self-provided information credentialing information such as work history and education history.

Users in these on-demand networks register for access to the network's offered information which is delivered via a WAN such as the internet with provision of a fee.

The current state of the art is inefficient and poses risks and limitations to the employers. Specifically, the accuracy of user provided information is presumed. For instance, claims by a prospective employee professing to have been employed during certain dates, by certain employers, or claiming to have completed degrees at certain institutions, is not verified. Other credentialing information goes likewise unverified, such as claims of security clearances, military service, rank and even credit, civil and criminal histories.

The risks to employers who rely and such information is profound, particularly in tort. Prospective employers presume that information provided via a reputable information service provider comes with the imprimatur of the information service provider and employers are generally reliant on this information with additional vetting process. Wrongful termination lawsuit often follow the termination of even employees terminated for cause for misrepresenting themselves during the application process. Open shop and right to work laws make verification of credentials all the more important.

Additionally, an employer's ability to verify the numerous credentials of all hundreds of applicants for dozens of positions is limited when attempted manually and by the economics of scale. Backgrounds searches are expensive.

Other complications arise with credentialing, including the impracticality and expensive of background searches which generally require considerable coordination between the prospective employers, investigators and numerous prospective employees.

The prior art fails to provide solutions to these inefficiencies. As such, there is a need in the art for a method and system for verifying credentials of prospective employees before prospective employer consideration.

### SUMMARY OF THE INVENTION

From the foregoing discussion, it should be apparent that a need exists for a computer program product, method and system for verifying user-provided credentialing information. Beneficially, such an invention would allow solve the above-described inefficiencies in the art and realize additional benefit to employers through the a verification system.

The present invention has been developed in response to the problems and needs in the art that have not yet been fully solved by currently available apparati and methods. Accordingly, the present invention has been developed to provide a computer-implemented method for verifying an applicant-provided employment credential, the steps of the method comprising: creating a verification file in computer-readable DBMS memory comprising: applicant data comprising: an applicant name, an applicant email address, a date range of applicant employment, a coworker name, a coworker email address, an employer name, and an employment title, and a credential comprising an employer name, an employer URL, a date range, and a title; exclusively associating a hyperlink to a user interface with the coworker for collecting verification information with a coworker; emailing the hyperlink to the coworker; accepting into computer-readable memory on a signal bearing medium a verification response from the coworker, the verification response comprising a timestamp and a plurality of Booleans each expressing confirmation or non-confirmation of an applicant datum input into one or more fields in a user interface; appending to the verification file a plurality of coworker Booleans, each coworker Boolean exclusively associated with an applicant datum, each coworker Boolean expressing verification or nonverification by a coworker of the applicant datum on a user interface; determining whether a predetermined number of coworker Booleans exceed a predetermined threshold for verification confirmation; appending a verification confirmation Boolean to the verification file, the verification confirmation Boolean expressed as positive to indicate satisfaction of the predetermined threshold; and indicating to one or more employers via a user interface that the verification confirmation Boolean is expressed as positive.

The method may further comprise eliminating an applicant from a group of applicants in response to a plurality of verification files exclusively associated with the applicant failing to satisfy the predetermined threshold.

The method may further comprise organizing applicants within a group of applicants such that applicants with a higher number of coworker Booleans expressed as positive are displayed in a user interface at the top of one of a stack, queue, and associate array.

The consumer selection criterion may be satisfied upon one or more of the Booleans exclusively associated with the following applicant data being positive: the employer name, the date range, and the title.

The method may further comprise emailing a code to the coworker email address comprising one of an integer and string exclusively associated with the coworker in the body of an email, and prompting the coworker to enter the code in a user interface.

The predetermined threshold is satisfied in response to the gTLD in the coworker email address being found identical to the gTLD defined in the employer URL.

The method may further comprise appending a coworker comment to the verification response, the coworker comment comprising a character string manually entered into a field in the user interface.

The verification file may further comprise a self verification confirmation Boolean expressed as positive in response to all of the following: the applicant activating a virtual self verification button in a user interface; a gTLD in the applicant email address corresponding identically to the employer URL; and independence of the date range of applicant employment.

The applicant data may be editable and dynamic through a user interface only while the verification confirmation Boolean is expressed as negative.

The applicant data may be static and noneditable through a user interface while the verification confirmation Boolean is expressed as positive.

A system configured to verifying an applicant-provided employment credential, the modules of the system comprising: a file creator module configured to create a verification file in computer-readable DBMS memory comprising: applicant data comprising: an applicant name, a date range of applicant employment, a coworker name, a coworker email address, an employer name, and an employment title, and a credential comprising an employer name, an employer URL, a date range, and a title; a code module configured to exclusively associate a hyperlink to a user interface with the coworker for collecting verification information with a coworker; an email module configured to email the hyperlink to the coworker; an acceptor module configured to accept into computer-readable memory on a signal bearing medium a verification response from the coworker, the verification response comprising a timestamp and a plurality of Booleans each expressing confirmation or nonconfirmation of an applicant datum input into one or more fields in a user interface; a first appendage module configured to append to the verification file a plurality of coworker Booleans, each coworker Boolean exclusively associated with an applicant datum, each coworker Boolean expressing verification or nonverification by a coworker of the applicant datum on a user interface; a determiner module configured to determine whether a predetermined number of coworker Booleans exceed a predetermined threshold for verification confirmation; a second appendage module configured to append a verification confirmation Boolean to the verification file, the verification confirmation Boolean expressed as positive to indicate satisfaction of the predetermined threshold; and an indicator module configured to indicate to one or more employers via a user interface that the verification confirmation Boolean is expressed as positive.

The may further comprise an eliminator module configured to eliminate an applicant from a group of applicants in response to a plurality of verification files exclusively associated with the applicant failing to satisfy the predetermined threshold.

The system may further comprise an organization module configured to organizing applicants within a group of applicants such that applicants with a higher number of coworker Booleans expressed as positive are displayed in a user interface at the top of one of a stack, queue, and associate array.

The consumer selection criterion may be satisfied upon one or more of the Booleans exclusively associated with the following applicant data being positive: the employer name, the date range, and the title.

The predetermined threshold may be satisfied in response to the gTLD in the coworker email address being found identical to the gTLD defined in the employer URL.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is user interface displayed in a generic browser to a user in accordance with the present invention;

FIG. 2 is a data entity-relationship diagram illustrating data flow between entities in accordance with the present invention;

FIG. 3 is user interface displayed in a generic browser to a user in accordance with the present invention;

FIG. 4 is a data entity-relationship diagram illustrating data flow between entities in accordance with the present invention;

FIG. 5 is block diagram of a system for verifying credentials in accordance with an embodiment of the present invention;

FIG. 6 is a computer readable file comprising credentialing and verification data in accordance with the present invention;

FIG. 7 is a data layout diagram illustrating a verification file in accordance with the present invention; and

FIG. 8 is a flow chart illustrating the steps of a method of verifying credentials in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are given to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The embodiments of the present invention described herein generally provide for a system, computer program product, and a method for verifying user submitted employment credentials using an online network to facilitate verification. Those individuals and entities desiring or needing employment are referred to hereinafter as “applicants” while employers are referred to hereinafter as “employers.” Similarly individuals or organizations who are willing to provide employment services or contracting services are herein referred to as “employers.” Reference to employers may include a tablet computer, smartphone, or DPD (data processing device) under the control of the consumer or provider. Additionally, the community described herein may be referred to as a network, group, friends, or family and these terms are synonymous as used throughout this specification. Employers may also be referred to collectively hereinafter as users. The technology provider may be a DPD or system of DPDs, including server(s), operating independently of the consumers and providers, configured to facilitate the receipt, maintenance and provision of information between the consumers and providers.

Hence, in general terms, the present invention provides for an online information provision service which facilitates the verification of employment credentials.

Determining that credentials are verified is provided for as follows herein.

Employment information may be fully verified or partially verified. The system, computer program product (CPP) and method can examine responsive information to verification request and determine automatically that employment information is verified. Alternatively the system, CPP and method can forward verification information for human review via a WAN.

Some embodiments of the method also assign a verification certainty score/qualifier based on the certainty of the verification or extent to which an applicant's credentials are verified. For instance, credentials that had been verified by a plurality of coworkers would receive a higher verification certainty score/qualifier than credentials verified by a single coworker.

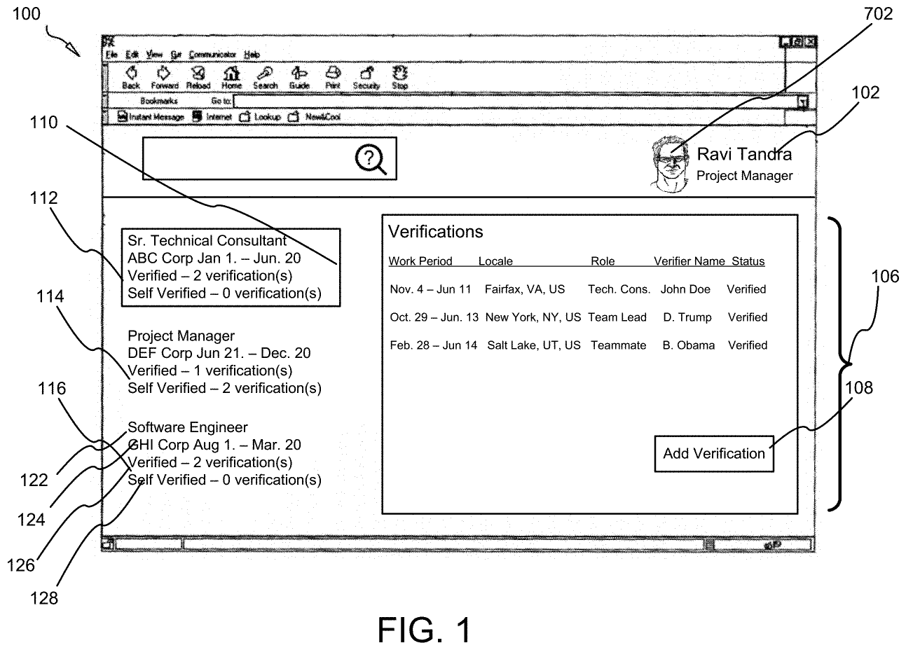

Accordingly, as illustrated, FIG. 1 depicts user interface 100 displayed in a generic browser to a user in accordance with the present invention. The user interface 100 indicated generally shows the various functional features that can be provided in the system 100 and methods described herein. For example, FIG. 1 shows one embodiment of a user interface 100 available to an applicant 102 whose photograph is depicted at 104. The employment history 106 of the applicant 102 is summarized in the user interface 100.

Virtual controls are displayed in the user interface, such as an “Add Verification” virtual button 108 which directs an applicant 102 to a screen further facilitating verification methodology.

Employment records 112-116 submitted/uploaded by the applicant 102 are detailed to the left of the user interface 100. The records are editable in some embodiments by selecting them from the left. Selected employment records 112-116 are highlighted using means known to those of skill in the art including indicating a box around the record 112-116. These records 112-116 are exclusively associated in computer-readable memory with the user 102 and comprise a string indicated an employer name 124, a title 122, a number of third-party verifications 126 accepted, and a number of self-verifications 128 accepted.

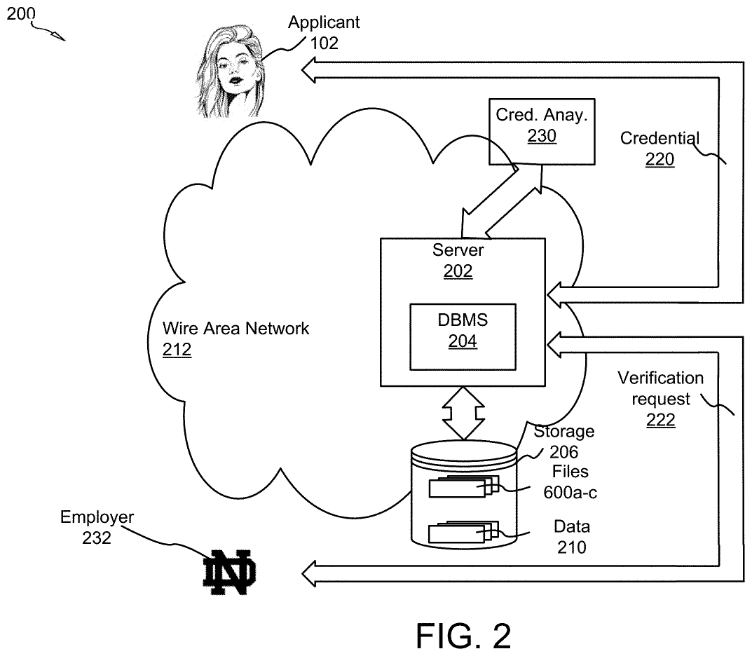

FIG. 2 is a data entity-relationship diagram illustrating data flow between entities in accordance with the present invention. The system 200 is shown and described broadly in FIG. 2. The system 200 depicts information flow between entities during a credentialing verification process.

The server 202 can receive real time data from applicants and employer for a given request for verification of credentials. The system 100 can also adjust the transaction matches based on previously stored preference data from requesters and providers. In this way, the system 100 can dynamically modify transaction matches to correlate with user preferences regarding not only which provider is available for delivery but which provider is preferred for delivery.

An applicant 102 uploads a credential 220 to a server 202, the credential 220 comprises a name 124, a title 122, and third-party verification information 126 and self verification information 128. The third-party verification information may comprise a time-stamp, indicated when the verification was received, the name of the verifier, a verification indicator comprising a Boolean value exclusively associated with a verifier name indicates positive or negative verification by the third-party verifier. In some embodiments, the verification indicator comprises a int having a value assigned representing a positive verification, a negative verification, a pending verification or an uncertain verification status. An overall verification score for the applicant 102 may be determined by the technology provider by referencing and balancing a plurality of verification indicators.

The system 200 can also include a processor that can receive, process, analyze, manipulate, store, and transmit data between the applicant 102 and employer 232, shown exemplarily as Notre Dame University. For example, the processor 114 can include a credential analysis module indicated generally at 230, that can receive credentials and forward verification requests to third-parties. A separate first verification module may be configured to receive, compare and analyze data received from third-parties against data previously stored in computer-readable member 206, including matching gTLDs (generic top level domain names) between an official employer URL and email addresses of third-parties. The server 202 which comprises the processor(s) also contains a DBMS 204 or RDBMS (relational database management system).

The verification data displayed in the user interface 100 may then be updated to reflect verifications confirmed.

The system 200 may include one or more processors that execute instructions on a computer-readable medium, such as a central processing unit or digital memory storage device 206, that cause the one or more processors to make a determination of whether user-provided credentials are verified.

The system 200 comprises a server 202, a database management system (DBMS) 204, persistent storage 206, stored verification files 600a-c, a wireless network 212, applicants 102, employers 232, a credential analysis module 230, and payment data 210 comprises credit card, banking or other payment information exclusively associated with an applicant 102.

Typically, the server 202 comprises one or more central processing units executing software and/or firmware to control and manage the other components within the system 200. In one embodiment, the server 202 comprises hardware and/or software more commonly referred to as a Multiple Virtual Storage (MVS), OS/390, zSeries/Operating System (z/OS), UNIX, Linux, or Windows system 100.

The server may comprise a server cluster with firewalls, load balancer, and database servers having Apache® and/or other software applications well-known to those of skill in the art. The database management system (DBMS) 204 or relational database management system (RDBMS), may comprise a DBMS such as Oracle, MySQL, SQL, FireBird, IBM DB2®, or the like.

The server 202 is in logical communication with the DPDs of one or more applicants 102 and one or more employers 232 through a networked environment 212, such as local area network (LAN) or wide area network (WAN) such as the Internet. The server 202 may communicate with applicants 102, employers 232 and/or coworkers by sending queues, verification files 600, and emails having codes or hyperlinks using variations of the Simple Mail Transfer Protocol (SMTP), Internet Message Access Protocol (IMAP), Post Office Protocol (POP), or other protocols well-known to those of skill in the art.

In some embodiments, the server 202 collects payments from employers 232 and/or applicants 102 in accordance with parameters mutually agreed upon by the employer 232 and technology provider and/or a plurality of applicant(s) 120.

The employer 232 may comprise any person, company, government institution or organization that seeks to employ or contract with individuals. Each applicant 102 is incorporated by the technology provider via-a-vis the server 202. For the purposes of this patent, the terms “incorporate” and “incorporation” denote the act of formally enrolling, or creating an account for, an applicant 102 or employer 232. In typical embodiments, the registration takes place via a user interface on/in a browser, but may also be sent to the server 202 using programs well-known to those of skill in the art, such as Microsoft Outlook, Thunderbird, Yahoo! Mail, and the like. In other embodiments, the applicants 102 and/or employers 232 are incorporated by receiving personal information via an API from a social media provider such as Google®, Facebook®, Twitter®, Instagram®, Snapchat®, or other social media providers known to those of skill in the art.

The applicants 102 consist of individuals but the employers 232 may comprise any person, company, or organization that is potentially an employer or contractor of another person, company, or organization.

The DPDs may comprise any system, apparatus, or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”). The DPDs may comprise a smartphone which, internally or externally, may comprise an Interactive Voice Response (IVR), which recognizes natural voice communication or DTMF keypad input.

The system may comprise a merchant processor such as Elavon®, PayPal®, or the like. In various embodiments, the server 202 may comprise, or be in logical communication with, an SMS gateway provider which relays short messages between the server 202 and/or applicant 102 and/or employers 232.

The processor can make a determination as to whether, and to what extent, a credential is verified.

In one aspect, the system 200 can also include a plurality of mobile computing devices, such as smartphones and tablet computers. In another aspect, the one or more processors can include programming to make a determination of which applicant meet or exceed certain employer-defined minimum thresholds.

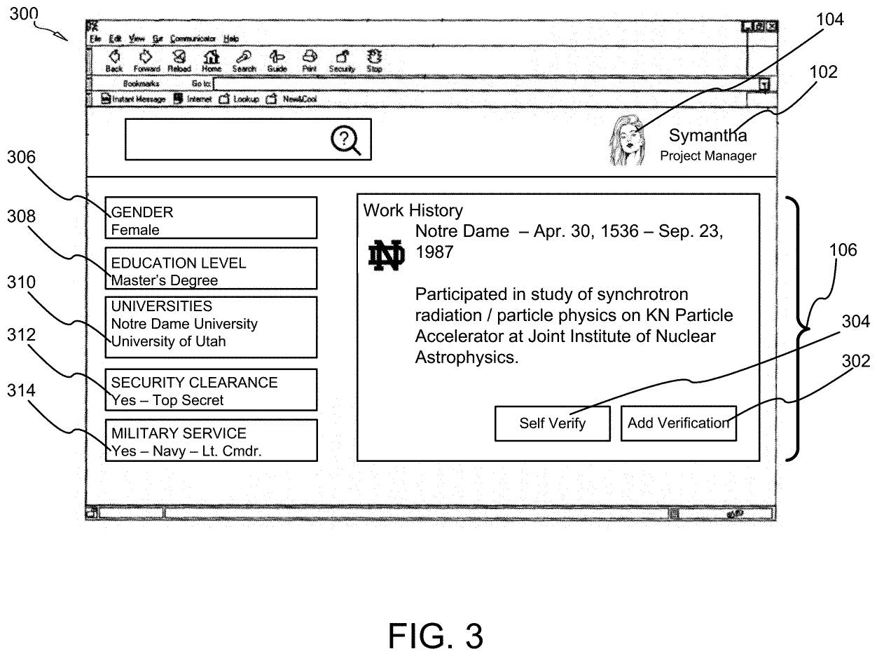

FIG. 3 depicts user interface 300 displayed in a generic browser to a user in accordance with the present invention. The user interface 300 indicated generally shows the various functional features that can be provided in the system 200 and methods described herein.

Applicants 102 provide data that is received and stored and exclusively associated with the applicant 102 in a DBMS 204. In this case, the applicant data can include a gender 306 Boolean, an education level 308, a detailed education history 310 including the names of one or more universities, the degrees received, the existence of, and type of, security clearance 312, military service records 314, and the like.

In some embodiments, applicants 102 are prompted by the user interface 300 to self verify by activating (or clicking on) a virtual button 304 such as radio button or other virtual inputs known to those of skill in the art. In these embodiments, the server 202 runs a comparison with other verification files 600 to ensure independency of the date ranges 124 in all other verification files 600 exclusively associated with the applicant 102. Independency is defined in this disclosure as date ranges 124 in a verification file 600 which have been cross-referenced with date ranges 124 in other verification files 600 and been found not overlap or in which data match checks are negative. In this manner, self verification is available and confirmed only for credentials 610 having date ranges 124 existing independently of the date ranges 124 in other verification files 600.

A matching algorithm or matching module may also ensure, or be configured to ensure, that an employer name submitted in a verification file corresponds to an employer URL submitted in the verification file. The matching algorithm may make reference to the gTLD during self-verification procedures in the applicant's 102 email address contained in the applicant info 104 to ensure the gTLD expressed in the applicant's email 102 matches the employer URL identically.

In various embodiments, applicants are prompted with virtual buttons 302, 304 to create a verification request 600 (further described below). New verification requests 600 may comprise integers, strings, objects, computer files and/or data types or alternatively may be appended to existing verification request 600.

In some embodiments, a verification request 600 is stored in computer-readable memory as a readable-file while in other embodiments, multiple item requests are correlated or exclusively associated with an applicant 600, including verification requests for each employer, school, or credentialing organization/institution, such as a state bar association or state department of licensing. Multiple verification requests 600 exclusively associated with said applicant 102 may be organized within a larger scheduling file and/or may be sorted and stored in an (R)DBMS.

Verification confirmation data can be transmitted via the one or more processors to employers 232. An online email tool can be incorporated into the system 200 to allow applicants 102 and coworkers of the applicants 102 to communicate additional details of a proposed verification including prompting a coworker to accept or reject a verification request. The one or more processors can use input from the applicant 102 and coworkers to determine whether received verification information from a coworker satisfied a predetermined criteria established in computer-readable memory on a server 202 and/or by a prospective employer 232.

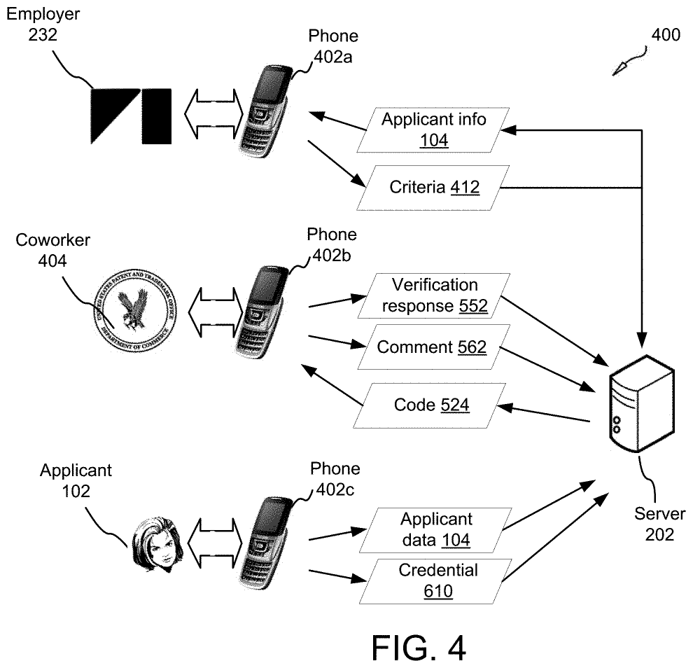

FIG. 4 is a data entity-relationship diagram illustrating data flow between entities in accordance with the present invention.

As shown, applicant data 104 is uploaded by the applicant 102 along with a credential 610 to a sever 202 under the control of the technology provider. A coworker 404 receives a code 524 (described further below) used to verify the coworker's identity. The coworker 404 way upload or input a comment 562 and/or verification response(s) 552 to the server 202.

Employer 232 may receive the applicant data 104 and may also upload criteria 412 to the server 202 to filter the profiles of applicants 102 being relayed to the employer 232.

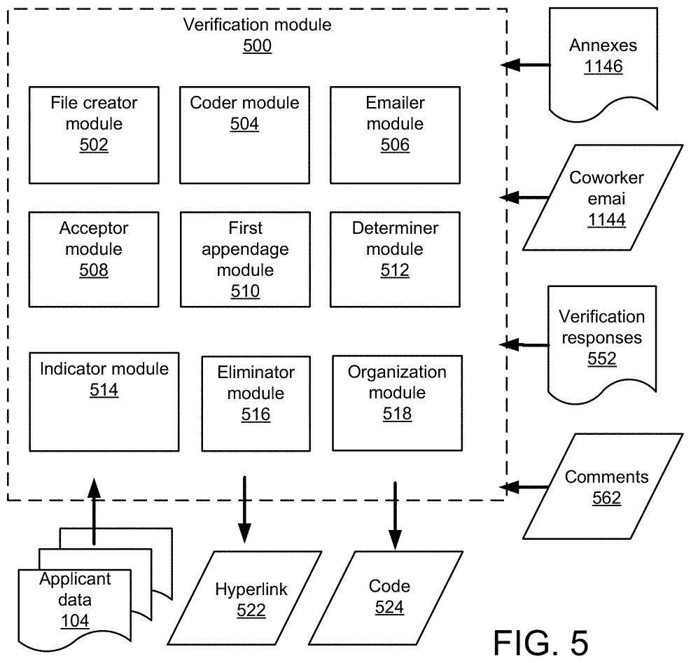

FIG. 5 is block diagram of a system 500 for verifying credentials in accordance with an embodiment of the present invention.

The system 500 modules may include the software, firmware, and hardware necessary to receive and process and append verification files 600 between applicants 102 and employers 232 and the technology provider, including buffers, data unloaders, mail clients, video unloaders, cameras, and the like.

Various parameters are passed to the system 500 from third-party sources, including inter alia, coworkers 404 and applicants 102.

In various embodiments, the matching module 520 comprises a delivery time subroutine which ensures coworkers have timely verified applicant info 104.

The social media subroutine determines, from inter alia a social media contacts parameter, how many social media contacts the applicant 102 and employer 232 share in common. The social media contacts information may originate with an API returning data to the system 500, such as Facebook®, Twitter®, or Google+® APIs as known to those of skill in the art.

The system 500 includes a file creator module configured to create a verification file in computer-readable DBMS memory comprising the applicant data 104, including a photograph, and also comprising one or more of an applicant name, a date range of applicant employment, a coworker name, a coworker email address, an employer name, and an employment title, and other demographic information about the applicant.

A credential comprising a data set having an employer name in a character string, an employer URL, a date range, and a title is uploaded to the technology provider and server 202 by the applicant 102. Employers 232 and employer names may be assigned and exclusively associated with a unique numeral in an int, float or char.

The system 500 includes a coder module 504 configured to exclusively associate a hyperlink 522 to a user interface with the coworker for collecting verification information with a coworker. This hyperlink is included in the verification request/file 600 and directs a coworker to a page on a user interface with allows manual verification responses 552 to be uploaded to the server 202 and/or the system 500. A code 524 may also be sent in the body of the email to the coworker. The code 524 is accepted in lieu of the correct hyperlink 522 resolution by the technology provider in those cases in which hyperlinks are redacted by employers 232 in employee emails.

An emailer module 506 is included in the system 500 and configured to email the hyperlink 522 to the coworker.

An acceptor module 508 is also included and configured to accept into computer-readable memory on a signal bearing medium a verification response from the coworker, the verification response comprising a timestamp and a plurality of Booleans each expressing confirmation or nonconfirmation of an applicant datum input into one or more fields in a user interface.

A first appendage module 510 is configured to append to the verification file a plurality of coworker Booleans, each coworker Boolean exclusively associated with an applicant datum, each coworker Boolean expressing verification or nonverification by a coworker of the applicant datum on a user interface.

A determiner module 512 is also included and configured to determine whether a predetermined number of coworker Booleans exceed a predetermined threshold for verification confirmation.

A second appendage module may be configured to append a verification confirmation Boolean to the verification file, the verification confirmation Boolean expressed as positive to indicate satisfaction of the predetermined threshold.

An indicator module 514 may be configured to indicate to one or more employers via a user interface that the verification confirmation Boolean is expressed as positive.

The system 500 may further comprise an eliminator module configured to eliminate an applicant from a group of applicants in response to a plurality of verification files exclusively associated with the applicant failing to satisfy the predetermined threshold.

The system 500 may also comprise an organization module configured to organizing applicants within a group of applicants such that applicants with a higher number of coworker Booleans expressed as positive are displayed in a user interface at the top of one of a stack, queue, and associate array.

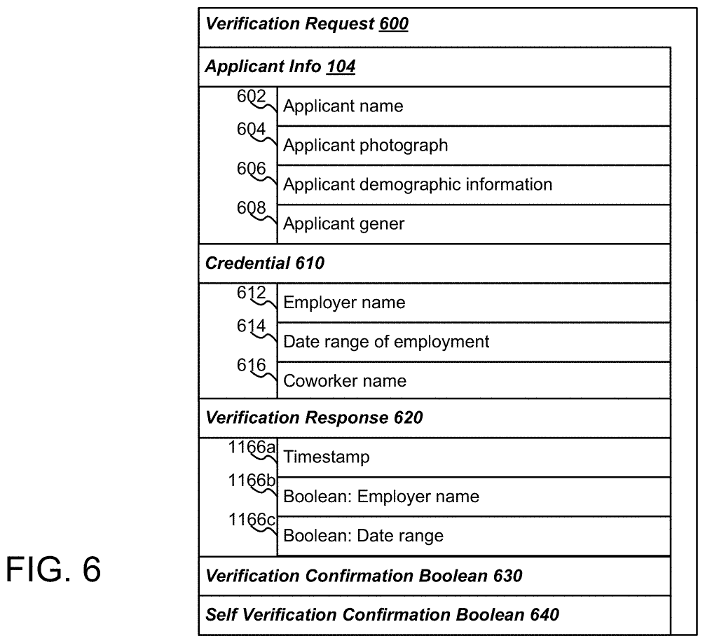

FIG. 6 is a computer readable file 600 comprising credentialing and verification data in accordance with the present invention.

A verification request 600 is received into computer-readable memory over a signal bearing medium. The verification request 600 may also be termed a “verification file.” The verification request 600 is further described below, but comprises a computer file, or a series of computer files, identifying an applicant 102 and employer with whom the applicant 102 formerly worked, associated or was employed. Applicant info 104 (or data) in included in the verification file 600. The applicant data 104 may comprise one or more media files comprising images and/or video and/or audio and/or text in the form of comments stored in strings, including files in JPG, WAV, MP4 and other formats known to those of skill in the art.

In various embodiments, a CPP, system, or method sends a communication to a third-party, such as a coworker, associate, contractor, boss, executive, or the like prompting said individual to return information to the server 202 and/or linking said individual to an online form through which said individual can provide confirming verification. In some embodiments, coworkers are given a predetermined period of time within which to respond and verify credentialing information during which the technology provider controlling the server 202 awaits a verification response 552, which may comprise Boolean information collected via dialog boxes or radio buttons in a user interface.

A verification response 620 from one or more coworkers is then accepted 262 and written into computer-readable memory. The verification response 620 may be transmitted from a wireless DPD over a WAN (wide area network) (and may comprise a simple variable such as a Boolean evaluated as true if the provider has accepted) to a computer-readable file in a DBMS with parameters or conditions of the provider acceptance.

The verification response 620 is forwarded from computer-readable memory to the technology provided with whom the framework for the verification request 600 originated. In various embodiments, only the first verification response 620 from a coworker is accepted by the technology provider. In other embodiments, a plurality of verification responses 620 are accepted and forwarded to the server 202 and/or technology provided, of which only the most recently received is operative.

In various embodiments, an applicant 102 is prompted to create a verification request.

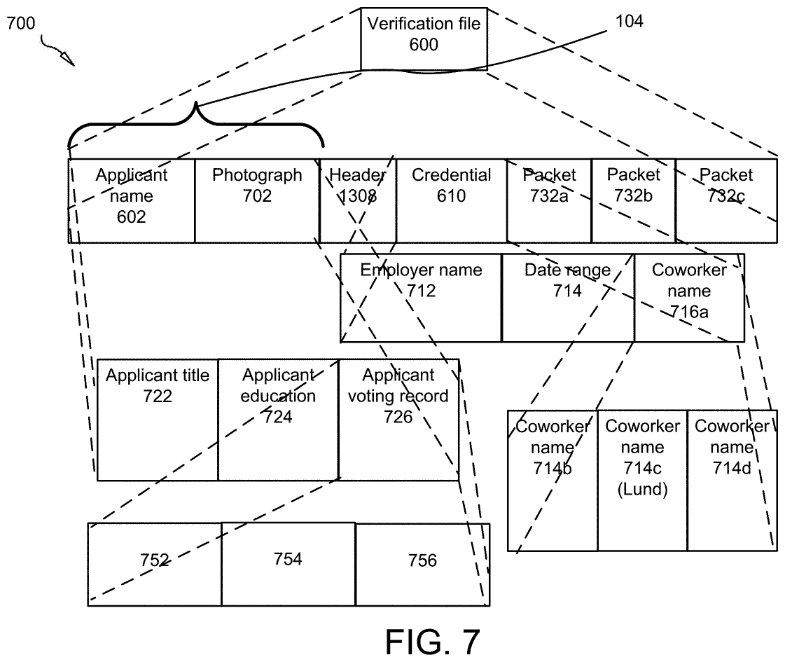

FIG. 7 is a data layout diagram illustrating one exemplary embodiment of a verification file 600 in accordance with the present invention.

The verification file 600 contains applicant data 104 including an applicant name 602 and applicant photograph 702. The data may include a title 722 such as “patent attorney” and education information 724; as well, in some embodiments, as an applicant voting record 726 or voting registration (including votes cast 752-756) for the purposes of inter alia of loyalty determination prediction, plus other information such as security clearance information and even religious preference information (unshown). The verification file 600 also contains a credential 610 comprising an employee name 712, a date range 714 of employment, and one or more coworker names 716a-d.

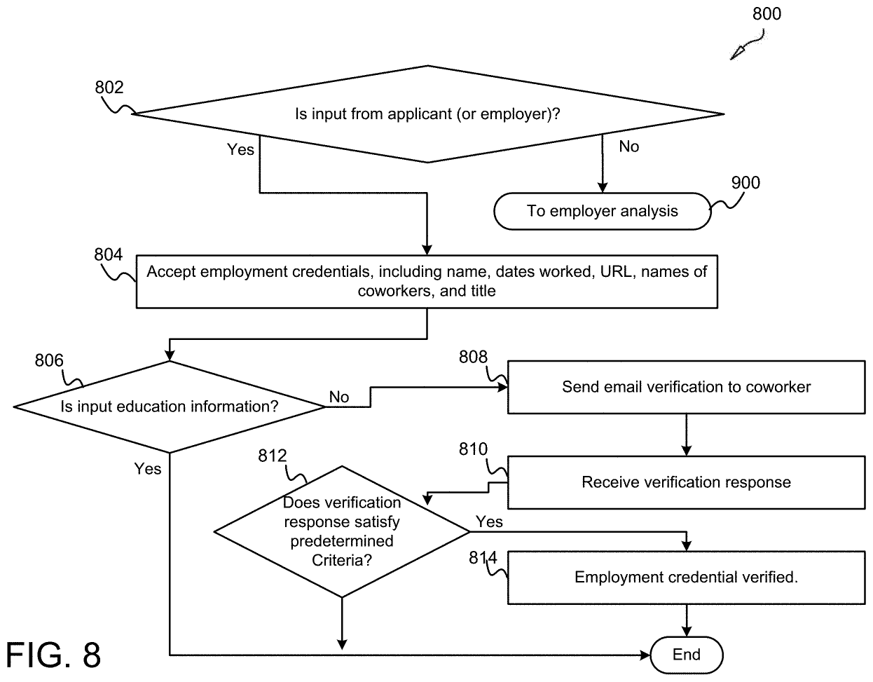

FIG. 8 is a flow chart illustrating the steps of a method 800 of verify credentials in accordance with the present invention.

The method 800 begins 802 when the technology provider accepts input from a user and performs a check to determine is an applicant 102 or an employer 232 is inputting the information. In an employer 232 is inputting the information, the method 800 terminates or continues with a method 900 (unshown).

Credentialing information is accepted 804 from the applicant 102. If the input comprises education credentials in a check at 806, the method 800 terminates. In the shown embodiment/variation, an email is sent by the emailer module 506 and a verification response 522 is received 810 and checked 812 to determine compliance with a predetermined criteria.

The method 800 can also allow an employer 232 to browse applicant 102 profiles meeting certain criteria. In this way, as the processor analysis yields possible applicants 102 matches which meet customized employer specifications stored in the (R)DBMS 204. In other embodiments of the invention, employers 232 may only be interested in applicants 102 meeting a predetermined credentialing criteria. An example would include, for instance, the Department of Energy (DOE) or Defense Intelligence Agency (DIA), which may only be interested in applicants 102 with a certain security clearance or even a narrowly-focused voting or religious history. The user-provided information may include political party registration or affiliation representations, which may be pertinent to the objectives of various 501(c)(4) organizations as examples. Exclusive identifiers may associate with religious denominations determined to be credentially valuable to employment considerations under criteria established by the employer 232.

The method also provides for employers 232 determining a verification satisfaction rating after conducting their own investigation, this employer-generated verification satisfaction rating also stored in the verification file 600. The ratings can be generated by data input by employers 232 and coworkers 404 in combination with one another and may represent a sliding quality scale or certainty rating.

It is a particular advantage that the method 800 also provides for employers 232 to see which representations, and how much of those representations, have been independently verified in a user interface 100. In some embodiments, misrepresentations are historically recorded in computer-readable memory 206 and associated with the misrepresenting applicant 102, including misrepresentation magnitude quantifiers expressed numerically in ints or floats having decimal points (e.g., 4155989.3). This allows employers 232 to save enormous time often used attempting to verify the statements/representations of applicants 102 over and over for their own limited purposes, which representations went unverified to the detriment of employers 232 and collective organizations previously in accordance with less-progressed methodologies in the art.

Employers 232 may also communicate directly with applicants 102 using either communication tools provided by the method application software, such as instant messaging or chat features and protocols, or by communication means external to the transaction broker method such as email, telephonic conversation, SMS texting, and the like.

The applicant name 602 may be a global char, in the shown embodiment, which contains the name of the applicant 102. In other embodiments, the applicant name 602 is an int (or integer) consisting of a value exclusively associated with said applicant 102 in hexadecimal (such as 1440FC39318163D) or in base ten (such as 39531126).

The employer name 612 may be a global char, in the shown embodiment, which contains the name of the employer 232 or coworker. In other embodiments, the employer name 612 is an int (or integer) consisting of a value exclusively associated with said employer 232.

The technology provider, or server 202, in the shown embodiment, may comprise one or more computer program products running on one or more data processing devices (DPDs), such as a server 202, computer workstation, router, mainframe computer, or the like. In various embodiments, the DPD comprises one or more processors or remotely networked DPDs. The user interface may be displayed in a browser using an API in various embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for verifying an applicant-provided employment credential, the steps of the method comprising:
creating a verification file in computer-readable DBMS memory comprising:
applicant data comprising: an applicant name, an applicant email address, a date range of applicant employment, a coworker name, a coworker email address, an employer name, and an employment title, and
a credential comprising an employer name, an employer URL, a date range, and a title;
exclusively associating a hyperlink to a user interface with the coworker for collecting verification information with a coworker;
emailing the hyperlink to the coworker;
accepting into computer-readable memory on a signal bearing medium a verification response from the coworker, the verification response comprising a timestamp and a plurality of Booleans each expressing confirmation or nonconfirmation of an applicant datum input into one or more fields in a user interface;
appending to the verification file a plurality of coworker Booleans, each coworker Boolean exclusively associated with an applicant datum, each coworker Boolean expressing verification or nonverification by a coworker of the applicant datum on a user interface;
determining whether a predetermined number of coworker Booleans exceed a predetermined threshold for verification confirmation;
appending a verification confirmation Boolean to the verification file, the verification confirmation Boolean expressed as positive to indicate satisfaction of the predetermined threshold; and
indicating to one or more employers via a user interface that the verification confirmation Boolean is expressed as positive.

2. The method of claim 1, further comprising eliminating an applicant from a group of applicants in response to a plurality of verification files exclusively associated with the applicant failing to satisfy the predetermined threshold.

3. The method of claim 2, further comprising organizing applicants within a group of applicants such that applicants with a higher number of coworker Booleans expressed as positive are displayed in a user interface at the top of one of a stack, queue, and associate array.

4. The method of claim 1, wherein the consumer selection criterion is satisfied upon one or more of the Booleans exclusively associated with the following applicant data being positive: the employer name, the date range, and the title.

5. The method of claim 1, further comprising emailing a code to the coworker email address comprising one of an integer and string exclusively associated with the coworker in the body of an email, and prompting the coworker to enter the code in a user interface.

6. The method of claim 1, wherein the predetermined threshold is satisfied in response to the gTLD in the coworker email address being found identical to the gTLD defined in the employer URL.

7. The method of claim 1, further comprising appending a coworker comment to the verification response, the coworker comment comprising a character string manually entered into a field in the user interface.

8. The method of claim 1, wherein the verification file further comprises a self verification confirmation Boolean expressed as positive in response to all of the following:
the applicant activating a virtual self-verification button in a user interface;
a gTLD in the applicant email address corresponding identically to the employer URL; and
independence of the date range of applicant employment.

9. The method of claim 1, in which the applicant data is editable and dynamic through a user interface only while the verification confirmation Boolean is expressed as negative.

10. The method of claim 1, in which the applicant data is static and noneditable through a user interface while the verification confirmation Boolean is expressed as positive.

11. A system configured to verifying an applicant-provided employment credential, the modules of the system comprising:
a file creator module configured to create a verification file in computer-readable DBMS memory comprising:
applicant data comprising: an applicant name, a date range of applicant employment, a coworker name, a coworker email address, an employer name, and an employment title, and
a credential comprising an employer name, an employer URL, a date range, and a title;
a coder module configured to exclusively associate a hyperlink to a user interface with the coworker for collecting verification information with a coworker;
an emailer module configured to email the hyperlink to the coworker;
an acceptor module configured to accept into computer-readable memory on a signal bearing medium a verification response from the coworker, the verification response comprising a timestamp and a plurality of Booleans each expressing confirmation or nonconfirmation of an applicant datum input into one or more fields in a user interface;
a first appendage module configured to append to the verification file a plurality of coworker Booleans, each coworker Boolean exclusively associated with an applicant datum, each coworker Boolean expressing verification or nonverification by a coworker of the applicant datum on a user interface;
a determiner module configured to determine whether a predetermined number of coworker Booleans exceed a predetermined threshold for verification confirmation;
a second appendage module configured to append a verification confirmation Boolean to the verification file, the verification confirmation Boolean expressed as positive to indicate satisfaction of the predetermined threshold; and
an indicator module configured to indicate to one or more employers via a user interface that the verification confirmation Boolean is expressed as positive.

12. The system of claim 10, further comprising an eliminator module configured to eliminate an applicant from a group of applicants in response to a plurality of verification files exclusively associated with the applicant failing to satisfy the predetermined threshold.

13. The system of claim 12, further comprising an organization module configured to organizing applicants within a group of applicants such that applicants with a higher number of coworker Booleans expressed as positive are displayed in a user interface at the top of one of a stack, queue, and associate array.

14. The system of claim 10, wherein the consumer selection criterion is satisfied upon one or more of the Booleans exclusively associated with the following applicant data being positive: the employer name, the date range, and the title.

15. The system of claim 10, wherein the predetermined threshold is satisfied in response to the gTLD in the coworker email address being found identical to the gTLD defined in the employer Uniform Resource Locator (URL).
